(19) United States
(12) Patent Application Publication
(10) Pub. No.: US 2003/0156702 A1
(43) Pub. Date: Aug. 21, 2003

(54) Method for establishing a telecommunication connection

(76) Inventors: Marian Trinkel, Kreuzau Ot Untermaubach (DE); Thomas Heider, Hirschaid (DE); Karl-Heinz Bayer, Bamberg (DE)

Correspondence Address: KENYON & KENYON, ONE BROADWAY, NEW YORK, NY, 10004, US

(21) Appl. No.: 10/332,362

(22) PCT Filed: Jun. 15, 2001
(86) PCT No.: PCT/EP01/06777

(30) Foreign Application Priority Data
Jul. 5, 2000 (DE) 100 32 757.5

(51) Int. Cl. H04M 7/00

(52) U.S. Cl. 379/219; 379/220.01

(57) ABSTRACT

Abstract A method is proposed for establishing a telecommunications connection from at least one subscriber line (1, 2) to at least one other subscriber line (1, 2) of a public telecommunications network (3), which is distinguished in that the telecommunications connection (5) for the at least two subscriber lines (1, 2) is established via a local connecting unit (4), and the local connecting unit (4) transmits data relevant to the telecommunications connection to a central control system (13), and data are transmitted from this control system (13) to the local connecting unit (4).

### BACKGROUND OF THE INVENTION

The present invention is directed to a method for establishing a telecommunications connection from at least one subscriber line to at least one other subscriber line of a public telecommunications network.

Based on the example of a phone card (virtual calling card) having a so-called prepaid function, the related art and the present invention are elucidated in the following: When using phone cards having the above mentioned function, a subscriber on a subscriber line selects an access phone number, via which he/she obtains access to the prepaid function, thus access to a central control system, by way of which the later phone connection or telecommunications connection is then supposed to be established. Here the related-art disadvantage also arises that the management of the telecommunications connection and the switching, i.e., establishing of the telecommunications connection, are handled via the central control system. The result, particularly in the context of a globalization of such a function, is very long connection paths, which ultimately make this service very expensive for the customer. This is because the subscriber line placing the call, for example in a foreign country, must first establish a telecommunications connection to the central control system, which then, via the telecommunications network, brings on line the subscriber line placing the call. If the called subscriber line is likewise in a foreign country, it is apparent that, ultimately, the telecommunications connection from the one subscriber line to the other subscriber line is first made from the foreign country into the country where the central control system is located, and a telecommunications connection is then established, in turn, by the central control system to the line in the foreign country. Thus, this telecommunications connection requires two long-distance connections, so that considerable costs are entailed.

It is, therefore, the object of the present invention to devise a method for establishing a telecommunications connection in which, on the one hand, the outlay for producing the telecommunications connection and, on the other hand, the costs for the telecommunications connection are reduced.

This objective is achieved by a method for establishing a telecommunications connection which has the features delineated in claim 1. This telecommunications connection is established from at least one subscriber line to at least one other subscriber line of a public telecommunications network. In accordance with the present invention, the method is distinguished in that the telecommunications connection for the at least two subscriber lines is established via a local connecting unit, and in that the local connecting unit transmits data relevant to the telecommunications connection to a central control system, and data are transmitted from this control system to the local connecting unit. In particular, the data transmitted by the local connecting unit to the control system are data pertaining to the duration of the telecommunications connection, in particular customer or card data, signaling information or the like. The method according to the present invention is interesting, particularly when the local connecting unit simultaneously connects and manages several telecommunications connections between two subscriber lines, so that the necessary data for the telecommunications connections are then transmitted via one single line or connection to the central control system. The data volume is very low for this connection in comparison to a telecommunications connection having voice communication, so that the management and rendering of accounts for a plurality of voice connections may be easily handled via one single line between the central control system and the local connecting unit. Nevertheless, via the local connecting unit, one subscriber or customer may obtain access to his/her personal customer data stored in the central control system. From this central control system, the customer may optionally also switch through to an operator, if he/she requires personal information. The telecommunications-connection data between two subscriber lines are thus managed within the central control system, so that, ultimately, the account processing, for example for the prepaid card, may also be handled here as well. A telecommunications billing account may also be easily managed centrally, since the connection data for the telecommunications connection between two subscriber lines are transmitted to the central control system.

Preferably, the local connecting unit establish and independently manage a plurality of telecommunications connections between at least two subscriber lines. The connection data that arise during a plurality of telecommunications connections are then transmitted to the central control system.

One further refinement of the present invention provides for a plurality of local connecting units, each thus having at least two subscriber lines and, accordingly, being able to establish and manage one or more telecommunications connections. Depending on the volume of telecommunications connections, the number of local connecting units may easily be increased, which then communicate with the central control system for purposes of data exchange.

In one preferred specific embodiment, the central control system assumes the task of managing the accounting and customer data, so that no further expenditure is required in this regard. Thus, the central control system that is already known and in operation may be retained.

Yet another aspect of the present invention provides for the subscriber lines to be connected to the local connecting unit via a public telecommunications network. If the at least one local connecting unit is in a foreign country, then the foreign telecommunications network may be used for the local telecommunications connection between the two subscriber lines. Via this network, the central control system may also be accessed for transmittal of the control data and/or customer data.

One preferred exemplary embodiment provides for the local connecting unit to be able to be dialed up directly from a subscriber line via an address or call-number identifier. There is, therefore, no need for the calling subscriber to connect to the central control system, so that this, by itself, already constitutes a reduction in the costs for a telecommunications connection, and the service is able to be offered altogether at lower, more competitive prices.

In one preferred specific embodiment, the connecting unit is addressable and controllable via a voice-recognition device, i.e., a sound- or voice-controlled dialog system. If a subscriber dials the local connecting unit, the unit may respond with a recorded text. If the subscriber answers, then the language being used is able to be recognized. The local connecting unit is then able to read out its questions or instructions to the subscriber in the corresponding, correct language. On the other hand, in a voice-controlled operation, the subscriber is able to request the service he/she desires. The local connecting unit is then able to easily establish a telecommunications connection from this subscriber to another subscriber. If the calling subscriber would like to make a query or obtain personal information, then he/she may be switched through to the local control system.

Thus, in a preferred embodiment, the connecting unit is itself able to switch telecommunications connections between two subscriber lines within the public telecommunications network.

As already mentioned above, a public telecommunications network may be used for the data exchange between the local connecting unit and central control system, and vice versa. Thus, as far as managing the connection data or customer data and managing a billing account are concerned, the outlay or costs involved are very low for a multiplicity of local telecommunications connections between two subscribers lines.

The present invention is elucidated in the following on the basis of exemplary embodiments, with reference to the drawing. Its figures show:

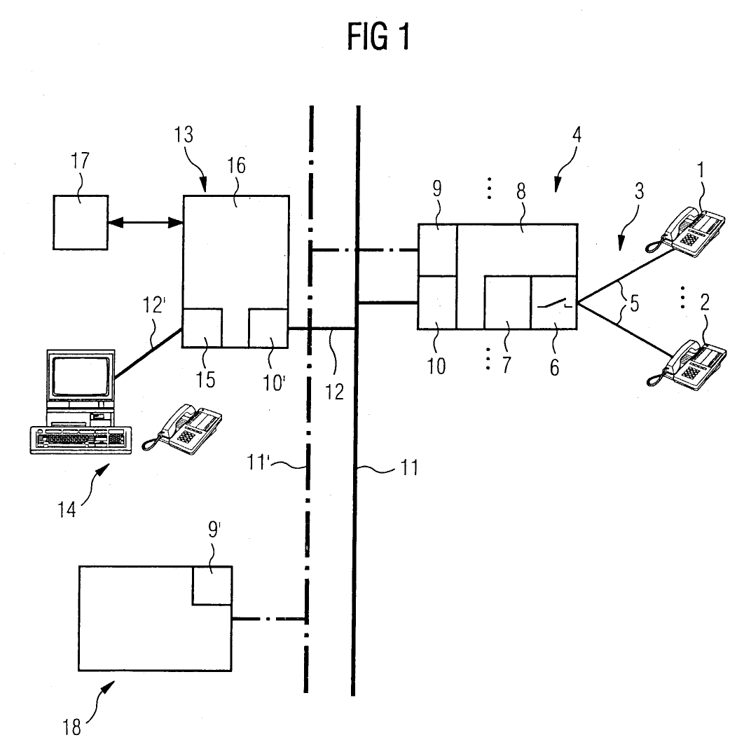

FIG. 1 a block diagram of a telecommunications network; and

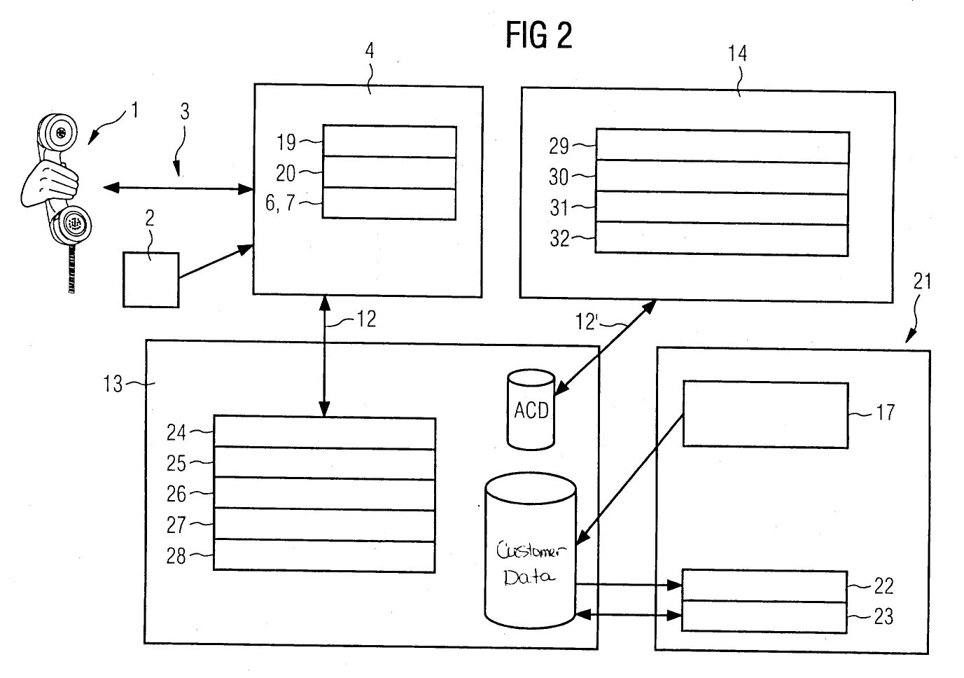

FIG. 2 the network elements of the telecommunications network according to FIG. 1, in a detailed view.

In FIG. 1, at least two subscriber lines 1 and 2 are integrated in a public telecommunications network 3. Connected to this telecommunications network is, moreover, at least one local connecting unit 4, which may also be described as a switching unit. Thus, between the two subscriber lines 1 and 2, connecting unit 4 is able to establish a telecommunications connection 5 via a switching element 6, which is addressed via a control unit 7. In addition, connecting unit 4 has a superordinated control device 8 which controls and monitors the entire connecting unit 4. In a preferred specific embodiment, control device 8 is a network server, which may be designed as a PC, for example, and be run using commercial software programs. Connecting unit 4 also has a control element 9 and a signaling device 10.

A plurality of identical connecting units 4 may be provided, which are then interconnected via a local network 11. This local network 11 is then able to be connected via a connection 12 to a central control system 13. For this, the central control system likewise has a signaling device 10′. By way of an interface device 15, a call center, including an operator work station 14, may be connected via a further connection 12′ to the central control system. The management of the customer and connection data is handled by a processing unit 16 of central control system 13, so that these data are able to be transmitted to an invoicing device 17, i.e., calculation or billing of charges.

Via a further local network 11′, local connecting units 4 may be connected to a superordinated network-control device 18, which—as is every connecting unit 4—is equipped with a control element 9′. Thus, network-control element 18 may assume the network management of all of the local connecting units 4. In one preferred specific embodiment, network-control element 18 is designed as a network server which may be implemented as a PC and run by a commercial operating system.

On the basis of FIGS. 1 and 2, the following explains in greater detail the establishment of telecommunications connections between subscriber lines 1 and 2 via public telecommunications network 3, as well as optional components of the individual components according to FIG. 1. Equivalent parts, i.e., parts performing equivalent functions as in FIG. 1, are denoted by the same reference numerals in FIG. 2, so that reference is made to their description. A subscriber on subscriber line 1 directly dials up connecting unit 4 via telecommunications network 3. Within connecting unit 4, he/she is then switched to a sound- or voice-controlled dialog system 19 which includes, moreover, a voice-recognition module 20. In accordance with the language of the subscriber on line 1, dialog system 19 may accept requests or queries in the correct national language, and provide information or issue instructions. If the subscriber on line 1 would like a connection or to be switched, thus for a telecommunications connection to be set up to subscriber line 2, the switching is carried out by switching element 6 and its control unit 7 using switching technology. Prior to or during establishment of the telecommunications connection between lines 1 and 2, local connecting unit 4 may exchange data with central control system 13 via connection 12, which may be implemented via a public telecommunications network. For this, a so-called on-line communications is preferably used. By way of external interfaces 21, the customer data stored in the central control system may also be used for expanded functions. Thus, one of external interfaces 21 may be invoicing device 17 or the billing device, which the customer on line 1 may also use, for example, to refill his/her phone card. Of course, the customer data and telecommunications-connection data may also be collected on an invoice via a device 22, or be debited via the customer's credit card. Furthermore, via local connecting unit 4, on-line communications connection 12, and central control system 13, the customer on subscriber line 1 may also call up special functions in a device 23, such as reservations or the like.

Prior to or during establishment of the local telecommunications connection from line 1 to line 2, the customer authorization may be undertaken in an authorization device 24 of central control system 13. In an automatic call-distribution device 25, calls and connection data may be managed and relayed. Also optionally provided is an electronic warehouse 26, from which the customer may select the desired goods. Also provided is a falsification-security device 27, which, on the basis of customer or voice parameters, recognizes whether a manipulation is being attempted by the customer or user. Finally, an account balance statement 28 is optionally provided, from which the customer may query his/her current billing status or refill status of his/her phone card.

Via connection 12′, customer queries may also be routed to operator workstation 14. A customer and account management 29 may be provided at this workstation. Moreover, a device 30 for the PAN/PIN validation by the operator may be provided. Value-added services 31, such as directory assistance or the like, may also be provided. A manual switching 32 may also be carried out via workstation 14.

Overall, therefore, the central, vitally important control system 13, which is also described as a master application and which assumes, for example, the task of managing accounting and customer data, is retained. On the other hand, local connecting units 4 are very flexible and provide a cost-effective design, so that telecommunications connections from a line 1 to a line 2 may be offered at very low, competitive prices. Compared to a purely central design approach, which necessitates exchanging all of the connection and voice data, the total costs are substantially less. For local connecting units 14, commercial PCs may be used, which likewise work with commercial operating systems, so that, in this regard, the costs are low, particularly in the context of an expansion to a plurality of local connecting units 4.

What is claimed is:

1. A method for establishing a telecommunications connection from at least one subscriber line (1, 2) to at least one other subscriber line (1, 2) of a public telecommunications network (3), wherein the telecommunications connection (5) for the at least two subscriber lines (1, 2) is established via a local connecting unit (4), and the local connecting unit (4) transmits data relevant to the telecommunications connection to a central control system (13), and data are transmitted from this control system (13) to the local connecting unit (4).

2. The method as recited in claim 1, wherein a plurality of connecting units (4) are interconnected via a local network (11), each connecting unit (4) having at least two subscriber lines (1, 2).

3. The method as recited in claim 1, wherein the central control system (13) assumes the task of managing the accounting and customer data.

4. The method as recited in one of the preceding claims, wherein the subscriber lines (1, 2) are connected to the local connecting unit (4) via a public telecommunications network (3).

5. The method as recited in one of the preceding claims, wherein the local connecting unit (4) is able to be dialed up directly from one of the subscriber lines (1, 2) via an address or call-number identifier.

6. The method as recited in one of the preceding claims, wherein the connecting unit (4) is addressable and controllable via a voice-recognition device (20) and a sound- or voice-controlled dialog system (19).

7. The method as recited in one of the preceding claims, wherein the connecting unit (4) itself switches telecommunications connection (5) between two lines (1, 2).

8. The method as recited in claim 1, wherein the data are exchanged between the control system (13) and the connecting unit (4) via a public telecommunications network (12).
